(19) United States
(12) Patent Application Publication
(10) Pub. No.: US 2022/0134985 A1
(43) Pub. Date: May 5, 2022

(54) Self-Restrained Radiator Protection and Filter

(71) Applicant: Sahil Patel, Mahwah, NJ (US)

(72) Inventor: Sahil Patel, Mahwah, NJ (US)

(21) Appl. No.: 17/085,711

(22) Filed: Oct. 30, 2020

(51) Int. Cl. B60R 19/52; B32B 7/05

(52) U.S. Cl. CPC B60R 19/52; B32B 7/05; B32B 2307/724; B32B 2605/00; B60R 2019/525

(57) ABSTRACT

A radiator protection device that protects a vehicle radiator from debris and damage is disclosed. The device is a multi-layer system that is flexible enough to be installed and removed through the radiator grill or other openings into the vehicle's radiator compartment. Installed configuration requires no mounting features nor support provisions due to the nature of fitment and resiliency of device to return to original shape.

### PRIOR FILED PROVISIONAL PATENT BENEFIT REQUESTED

Provisional Patent Application Number: 63/044,701 on 26 Jun. 2020 confirmation no. 1564

### REFERENCES CITED

U.S. Pat. No. 9,834,161 B2 “ROCK GUARD FOR HIGHWAY VEHICLES” Same as 9,333,929 B2, but added more claims including application to a vehicle claim.

U.S. Pat. No. 9,320,999 B2 “METHOD AND DEVICE FOR REMOVING AIRBORNE POLLUTANTS” ‘Compressing a multilayer filter having a peripheral edge in a forward section of a vehicle’; ‘filter expanding to fill the space’

U.S. Pat. No. 9,925,938 B2 “GRILLE INSERT FOR PROTECTING MOTOR VEHICLE RADIATOR” Metallic material grille insert (Jeep Wrangler)

U.S. Pat. No. 4,917,203 “RADIATOR COVER FOR MOTOR VEHICLES” Cover with u-shape frame that covers the front of car grille.

U.S. Pat. No. 6,810,950 B1 “RADIATOR COVER” Radiator assembly with hanging cover and filter assembly that slides into it from the top.+

### BACKGROUND OF THE INVENTION

This invention primarily relates to the protection of automotive vehicle radiators as a motor vehicle technology. Radiator performance can be defined as its ability to move heat from the internal fluid such as engine coolant to the external fluid such as ambient air. When a radiator's air flow is reduced due to debris and insects clogging the radiator's fins its performance is in turn reduced. Furthermore, damages such as those from pebble impact may result in puncture and bent fins which reduce performance.

Difficult to access radiators such as those found on sports cars, where the radiator is located low and forward of the front wheels, are normally surrounded by vehicle components making the installation of prior art radiator protectors challenging. In these cases, access to the radiator is possible only through the front radiator grill openings. Most prior art require vehicle disassembly to gain sufficient installation access to these radiators, except for front exterior mounted prior arts.

Many radiator protection devices are typically designed to be installed through an access along one entire edge of the radiator when the hood is opened. These often require access and space to facilitate mounting provisions such as presented in U.S. Pat. Nos. 9,925,938, 9,320,999, and 6,810,950. This access enables the protection device to be installed with ease by sliding it into place in front of the radiator. Some prior arts include frames and mounting features to facilitate installation on the front vehicle exterior as in U.S. Pat. Nos. 4,917,203 and 9,834,161 to retain the protection device on the vehicle. In this case, the user may find it aesthetically undesirable unwilling to risk abrasion to vehicle exterior surfaces to mount radiator protection on the vehicle's front exterior.

### BRIEF SUMMARY OF THE INVENTION

Primary objects of this radiator protector invention are debris filtration, pebble impact protection, high temperature resistant, paintable, ease of installation, and the aversion to restraints or mounting requirements. These objectives in total provide an effective and economical device including installation. The features that provide debris filtration and impact absorption also provide flexibility and resiliency allowing it to be installed upon radiators that are very difficult to access yet be effective.

It is flexible enough to be folded or contorted into shape that may pass through a small radiator grill opening and be resilient enough to recover back to the original shape allowing it to fully cover the radiator surface. With it sized correctly, it does not need any restraints nor mounting provisions because the radiator forward cavity surrounds restrain it in all directions. Furthermore, the air flow forces the invention against the radiator surface holding it in place during vehicle operation. These features allow one to preclude the use of tools and vehicle disassembly for applying this invention.

Aesthetic and convenience objects of the invention are that it is paintable and reversable such that the invention can be installed to have either face forward to the air stream. This feature allows the user to have one side painted a different color than the other side which allows the user convenience of changing the color by simply removing and re-installing the invention with the desired face facing forward.

### BRIEF DESCRIPTION OF THE SEVERAL VIEWS OF THE DRAWING

FIG. 1 shows an embodiment of the radiator protection device according to the present disclosure.

FIG. 2A shows a side view of the device of FIG. 1.

FIG. 2B shows a cross sectional view of the device of FIG. 1.

FIG. 3A shows an embodiment of the device prior to installation according to the present disclosure.

FIG. 3B shows an embodiment of the device installed into a vehicle between the vehicle's front structure and radiator grille.

FIG. 4A shows an embodiment of the device during installation or removal.

FIG. 4B shows an embodiment of the device installed into a vehicle between the vehicle's radiator grille and radiator.

### DETAILED DESCRIPTION OF THE INVENTION

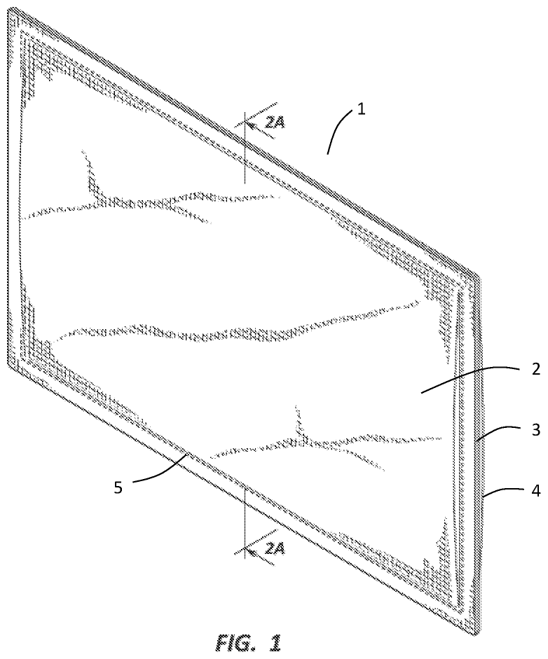

The radiator protection device 1 disclosed is shown in FIG. 1 as an exemplary embodiment having a thick layer 3 sandwiched by a first thin layer 2 and second thin layer 2 bound together with sewn hem perimeter binding 5. The layers provide debris trapping and debris impact energy dissipation while allowing air passage sufficient for the vehicle 9 radiator 8 to operate successfully. Device 1 perimeter profile shown in FIG. 1 is shown as rectangular of 4 linear sides, however the device 1 is not limited to this profile, various profiles are possible and required to fit specific vehicle 9 radiator compartments. Such profiles could have curved or straight sides. The perimeter profile could be of circle, triangle, rectangular, and greater sided polygon nature. The profile could also be irregular having cutouts to accommodate irregular radiator compartments. It is possible to add grommets to device 1 or uniquely shape device 1 with geometry that facilitates retention methods if one requires.

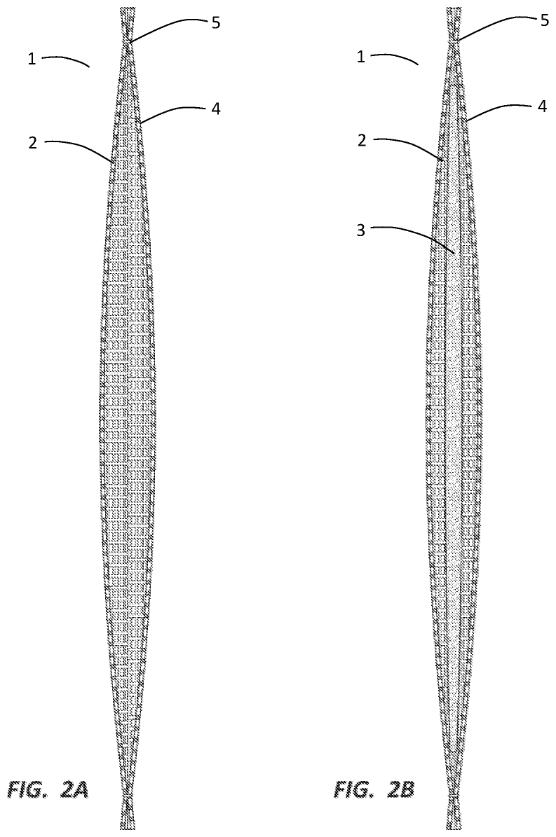

The layers are shown in FIG. 1 and FIG. 2B as bound along the perimeter as a sewn hem binding 5. Other binding methods and locations are possible. FIG. 2A presents a side view of device 1 depicting the binding 5. FIG. 2B reveals the composite construction of thick layer 3 and thin layers 2 with binding 5 in a cross-section view of device 1.

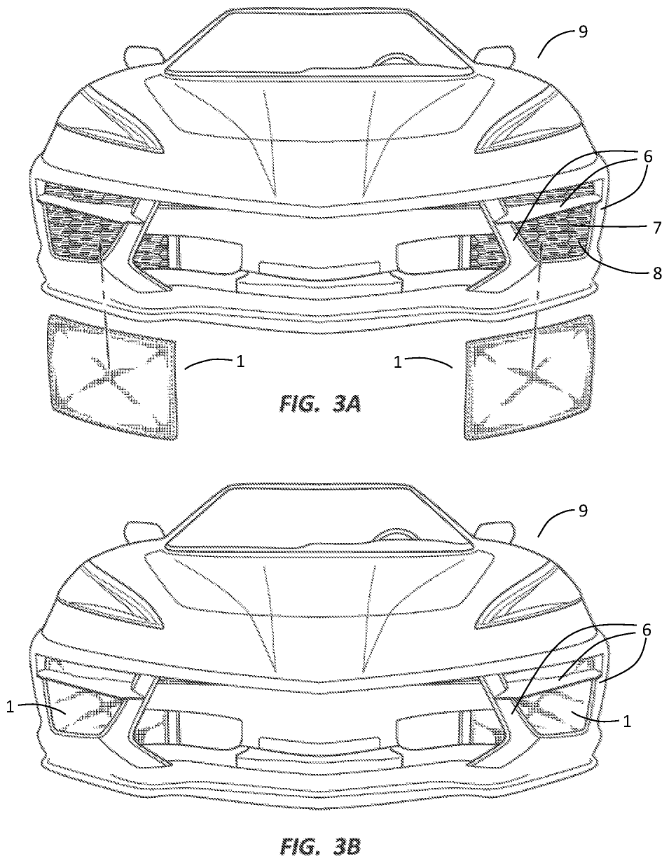

Vehicle 9 with bumper 6, radiator grill 7, and radiator 8 are schematically shown in FIG. 3A prior to installation of device 1. An installation embodiment of device 1 into vehicle 9 compartment between bumper 6 and grill 7 is depicted in FIG. 3B.

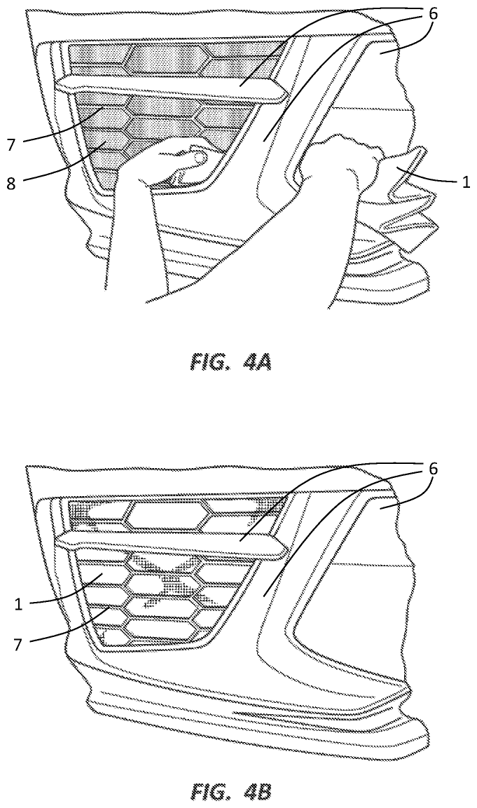

FIG. 4 illustrates device 1 flexibility allowing the user to contort device 1 into a shape allowing device 1 passage through bumper 6 or grill 7 small openings for installation.

An installation embodiment of device 1 into vehicle 9 compartment between grill 7 and radiator 8 is depicted in FIG. 4B. Device 1 does not require retention nor support artifacts because the installation compartments retain the device 1 fully. Installed device 1 movement retention in vehicle 9 airflow forward and reverse directions are provided by bumper 6, grill 7, or radiator 8. The device 1 is sized and shaped to the compartment dimensions and shape to ensure minimal motion of the device 1 during installed use. These compartments are such to retain device 1 in all directions of top, sides, and including the bottom to restrict gravity from pulling the device 1 down.

This detailed description of the invention discloses specific features and aspects but is not limited to other embodiments within scope of claims.

What is claimed is:

1. A vehicle radiator protection device comprising:
a. two or more material layers;
b. at least of both one thin layer and one thick layer;
c. all material layers have low resistance to air flow;
d. the layers bound together along the perimeter or internally;
e. main body outer perimeter having circular, linear, or curvilinear edges; and
f. main body perimeter edge as singular or a multitude of edges.

2. The protection device of claim 1, wherein a plurality of bounding locations exist along the perimeter as a hem or across the device area.

3. The protection device of claim 1, wherein bounding comprises of stitches.

4. The protection device of claim 1, wherein bounding comprises of adhesive.

5. The protection device of claim 1, wherein the planar shape is sized to fit forward the radiator in the radiator compartment.

6. The protection device of claim 1, wherein any layer is comprised of coated fiberglass.
